(19) United States
(12) Patent Application Publication
(10) Pub. No.: US 2013/0295542 A1
(43) Pub. Date: Nov. 7, 2013

(54) SIMULATION TRAINING DEVICE FOR ASSESSMENT OF CERVICAL DILATATION

(71) Applicants: Asha Krishna PRATINIDHI, Kolhapur (IN); Arvind KANHERE, Pune (IN); Aditya Krishna PRATINIDHI, Pune (IN); Aparna Nishikant SHROTRI, Pune (IN); Hemangi Parag KALE, Solon, OH (US); Nikhil Arvind KANHERE, Newmarket (CA)

(72) Inventors: Asha Krishna PRATINIDHI, Kolhapur (IN); Arvind KANHERE, Pune (IN); Aditya Krishna PRATINIDHI, Pune (IN); Aparna Nishikant SHROTRI, Pune (IN); Hemangi Parag KALE, Solon, OH (US); Nikhil Arvind KANHERE, Newmarket (CA)

(73) Assignee: KRISHNA INSTITUTE OF MEDICAL SCIENCES UNIVERSITY, Karad (IN)

(21) Appl. No.: 13/462,285

(22) Filed: May 2, 2012

(51) Int. Cl. G09B 23/28

(52) U.S. Cl. 434/272

(57) ABSTRACT

A simulating training device for assessment of cervical dilatation is provided. The device includes a supporting platform, a rotating plastic drum rigidly connected to a shaft and having a plurality of rubber-lined holes of varying diameters, a box which covers the rotating drum and has an opening, an indexing mechanism which has a spring-loaded lock and a slotted indexing wheel, a turn wheel which has an indication arrow, and a scale which identifies a diameter of each of the plurality of rubber-lined holes. Rotation of the turn wheel and the slotted indexing wheel causes one of the plurality of rubber-lined holes to be positioned in the center of the opening of the box one at a time. The turn wheel, the rotating drum and indexing mechanism are synchronized such that the indicating arrow of the turn wheel points to the diameter of the positioned hole on the scale.

### BACKGROUND OF THE INVENTION

The present invention relates to the field of medical sciences as a training tool for the assessment of cervical dilation for (i) undergraduate and postgraduate students studying obstetrics and gynecology; (ii) nursing students and professionals; and (iii) traditional birth attendants.

Conventionally, assessment of cervical dilatation of a patient is first performed by a teacher in obstetrics and gynecology, and then the student is asked to perform an internal examination of the patient. Next, the teacher informs the student of the cervical dilatation size of the cervix just examined by the student. The student must then commit to memory the relationship between the examination just performed and the particular cervical dilatation size of which he/she has been informed.

Such conventional training techniques transfer the subjective impression of one person to another person without facilitating visual guidance about the actual cervical dilatation size. Each and every student of medicine and nursing has to undergo such a training without facilities (e.g., a dummy model) for forming their own judgment. Such conventional training techniques are far from perfect and are likely to result in gaps in a student's training, such that the student is likely to have inaccurate judgment of the cervical dilatation assessments. Also, when a series of students palpate the patient internally as part of a training or teaching exercise, there is not only a risk of infection to the patient due to repeated internal examinations, but also a risk of psychological trauma and physical aggravation to the patient due to repeated vaginal examinations.

Thus, it would be beneficial to provide a simulation training device which facilitates accurate cervical dilatation assessments by students and is not invasive for patients.

### BRIEF SUMMARY OF THE INVENTION

Briefly stated, in one embodiment, the present invention is directed to a simulating training device for assessment of cervical dilatation comprising a supporting platform for supporting components of the device and a rotating plastic drum which is closed on both sides by plastic discs. The plastic discs are glued to the rotating drum and are connected to a shaft. The rotating drum is rigidly connected to the shaft and has a plurality of rubber-lined holes of varying diameters. A box covers the rotating drum and has an opening which is selectively coverable by an opaque cloth or curtain. The device further includes an indexing mechanism, a turn wheel and a scale. The indexing mechanism has a spring-loaded lock and a slotted indexing wheel, wherein the slotted indexing wheel is fixed to the shaft and allows the rotating drum to rotate in one direction. The turn wheel is mounted on the shaft and has a handle and an indication arrow. The scale identifies a diameter of each of the plurality of rubber-lined holes. Rotation of the turn wheel and the slotted indexing wheel causes one of the plurality of rubber-lined holes to be positioned in the center of the opening of the box one at a time. The turn wheel, the rotating drum and indexing mechanism are synchronized such that the indicating arrow of the turn wheel points to the diameter of the positioned hole on the scale.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings an embodiment which is presently preferred. It should be understood, however, that the invention is not limited to the precise arrangements shown.

In the drawings:

FIG. 1 is a top cross-sectional view of a rotating drum assembly of a simulation training device in accordance with an embodiment of the present invention;

FIG. 2 is a front cross-sectional view of a simulation training device in accordance with an embodiment of the present invention;

FIG. 3 is a top view of a simulation training device in accordance with an embodiment of the present invention;

FIG. 4 is a front elevational view of a simulation training device in accordance with an embodiment of the present invention with a covering box positioned over the rotating drum; and

FIG. 5 is a right side elevational view of a simulation training device in accordance with an embodiment of the present invention.

### DETAILED DESCRIPTION OF THE INVENTION

A preferred embodiment of the present invention relates to a simulation training device for the assessment of the cervical dilatation. The simulation training device was designed so that one can practice and perfect oneself in judging the size of dilatation accurately before actually performing internal vaginal examination for assessing cervical dilatation in a human patient.

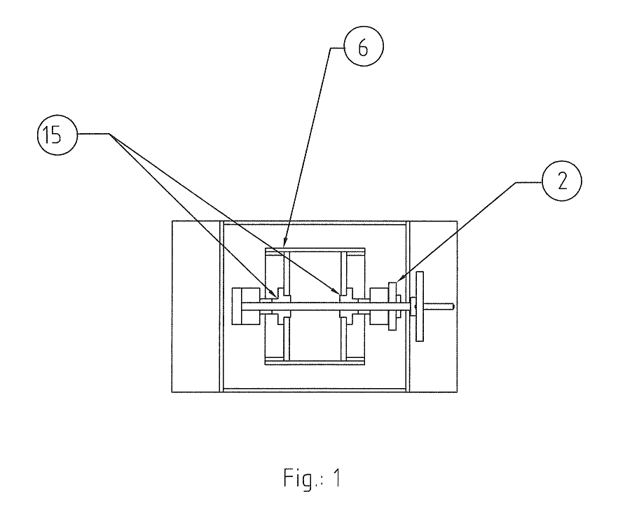

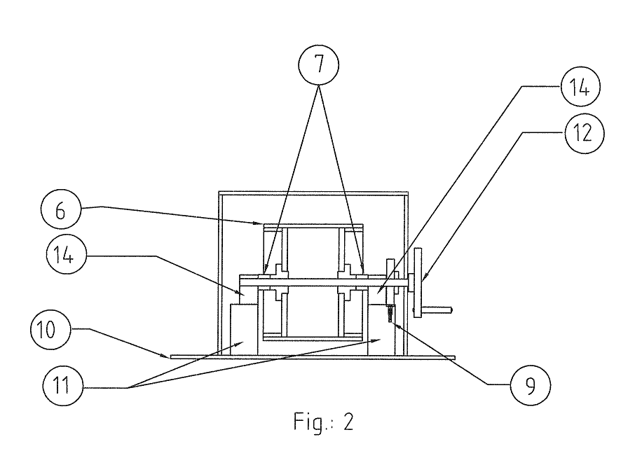

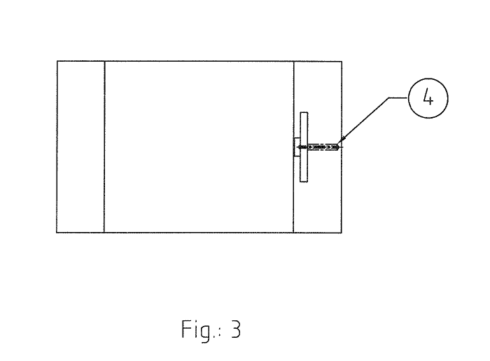

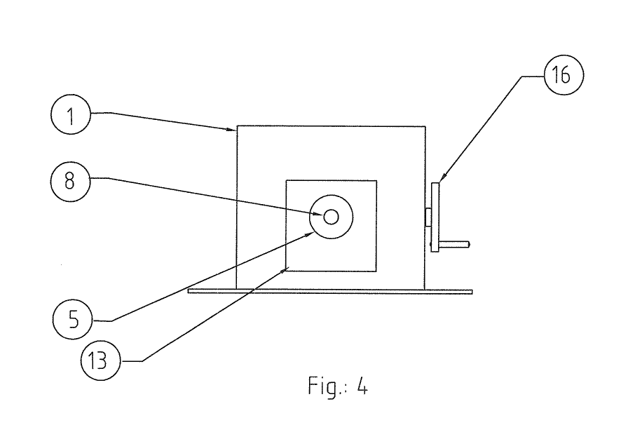

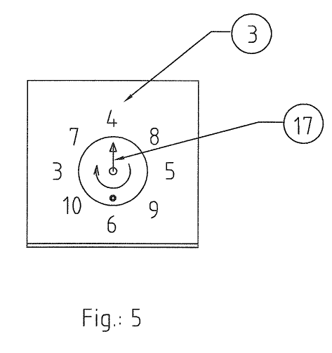

Referring to FIGS. 1-5, there is shown a simulation device for training students in obstetrics and gynecology for making determinations of the size of cervical dilatation from 3 centimeters to 10 centimeters. Thus, students learn how to determine cervical dilatation sizes on an inanimate object before embarking on vaginal examination for judging cervical dilatation in a human subject.

The device comprises a block board platform 10 for supporting the various components of the device and a rotating plastic drum or cylinder 6. The rotating drum 6 is closed on both sides by plastic discs which are glued to the rotating drum 6. The plastic discs, in turn, are connected to a shaft 12 via a wooded hub 15 disposed on each side of the rotating drum 6. Each hub 15 is screwed to one of the plastic discs and to the shaft 12. Thus, the rotating drum 6 is rigidly connected to the shaft 12. The shaft 12 is mounted in two wooden bearings 14 which are fixed on the block board 10 through support bearings 11 located on either side of the rotating drum 6.

The periphery of the rotating drum 6 is provided with a plurality of holes 8 ranging in diameter from 3 centimeters to 10 centimeters. Each of the holes 8 is fitted with rubber rings of a corresponding diameter. The rotating drum 6 is covered by a box 1 to ensure that the holes 8 on the rotating drum 6 cannot be seen from the outside and also to protect the inner components of the device. The box 1 comprises an opening 5 which is preferably covered by an opaque cloth or curtain 13. Preferably, the box is wooden and rectangular in shape, and the opening 5 preferably has a circular cross section.

An indexing mechanism is provided on the right-hand side of the device. The indexing mechanism comprises a spring-loaded lock 9 and a slotted indexing wheel 2. The slotted indexing wheel 2 is fixed to the shaft 12 by a screw. The shaft 12 extends out of the covering box 1 from the right-hand side of the box 1. A turn wheel 16 is mounted on the shaft 12 on the outside of the box 1. The indexing mechanism allows the rotating drum 6 to rotate in one direction and this direction of rotation is shown on the turn wheel 16 by a directional marking arrow. The turn wheel 16 also include a handle 4 for rotation of the turn wheel 16, the slotted indexing wheel 2 and the rotating drum 6.

The handle 4 can be used to rotate the rotating drum 6 and position a hole 8 of the desired diameter within the opening 5 of the box 1. Specifically, by using the handle 4 to rotate the slotted indexing wheel 2, the rubber ring fitted holes 8 of the rotating drum 6 can be brought into the center of the opening 5 of the box 1 one at a time. More specifically, by rotating the turn wheel 16, the holes 8 of the rotating drum 6 come one by one in line with the opening 5 of the box 1. The axial central position of the holes 8 is ensured by suitable spacers 7. The indexing mechanism synchronizes the hole diameter with the number of the hole 8 because the diameter of each hole 8 is indicated on a circular scale 3 printed on the box 1 and extending around the turn wheel 16. The turn wheel 16, the rotating drum 6 and the indexing mechanism are synchronized so that the diameter of each hole 8 of the rotating drum 6 is indexed in front of the opening 5 on the box 1 and is correctly indicated by an indicating arrow 17 provided on the turn wheel 16.

The rubber-lined hole 8 positioned within the center of the opening 5 can then be palpated by a trainee student. Since the opening 5 of the box 1 is covered with the curtain 13, the trainee can choose to view the hole 8 during palpation or not. Typically, during the beginning stages of training, the trainee will view the hole 8 during palpation of the hole 8 to become accustomed to the diameter of the hole 8 visually and by palpation. However, once the trainee has become so accustomed, the curtain 13 can be made to block the trainee from viewing the hole 8, and blind palpitations can be undertaken for each of the holes 8 by the trainee student, such that the trainee is required to judge the size of the hole 8 by palpation alone. This is very important because the main objective of the device is that each hole 8 of the rotating drum 6 may be palpated by hand with no visual aid whatsoever, thus simulating vaginal examination where one has to judge the size of cervical dilatation without the advantage of visually observing the dilatation. The trainee student has to learn how to judge the diameter of the hole 8 by sensing the hole diameter only by touching and then correlating that which he has sensed with the corresponding number directed by the arrow. After gaining confidence of his or her judgment of cervical dilatation by using the simulation device for performing repeated blind palpitations on the device, the trainee is now ready for performing examinations on human patients.

For use of the simulation device, the following steps are to be undertaken:

(i) Using the handle 4 to rotate the rotating drum 6, a circular rubber-lined hole 8 of a predetermined diameter is positioned within the circular opening 5 of the box 1.

(ii) The trainee is then able to observe the circular rubber-lined hole 8 positioned in the circular opening 5.

(iii) The student palpates the rubber-lined hole 8 as many times as necessary to commit to memory the diameter which corresponds to the palpated hole 8.

(iv) The ability of the trainee is then judged by preventing him or her from observing the hole 8 and requiring the trainee to blindly palpate the hole 8 and identify the diameter of the hole 8 in the range of 3 to 10 centimeters.

(v) Once the trainee has been trained to correctly identify the diameter of each hole 8, he or she is ready to perform vaginal examinations and judge cervical dilatation sizes in human patients.

These steps will facilitate the trainee to assess cervical dilatations accurately by the palpatory method. The device also has various applications and uses as follows:

(i) simulates vaginal examination;

(ii) saves repeated learning attempts at assessing cervical dilatation sizes on human patients;

(iii) is readily available and can be manipulated to fix known desired sizes of openings on the device;

(iv) enables repeated examinations on the device without any harm of infection or trauma to a human patient; and

(v) the trainer can objectively evaluate the progress of the trainee.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A simulating training device for assessment of cervical dilatation comprising
a platform for supporting components of the device;
a rotating plastic drum which is closed on both sides by plastic discs, the plastic discs being glued to the rotating drum and being connected to a shaft, the rotating drum being rigidly connected to the shaft, the rotating drum having a plurality of rubber-lined holes of varying diameters;
a box covering the rotating drum, the box having an opening which is selectively coverable by an opaque cloth;
an indexing mechanism having a spring-loaded lock and a slotted indexing wheel, the slotted indexing wheel being fixed to the shaft and allowing the rotating drum to rotate in one direction;
a turn wheel mounted on the shaft and having a handle and an indication arrow; and
a scale identifying a diameter of each of the plurality of rubber-lined holes;
wherein rotation of the turn wheel and the slotted indexing wheel causes one of the plurality of rubber-lined holes to be positioned in the center of the opening of the box one at a time, and
wherein the turn wheel, the rotating drum and indexing mechanism are synchronized such that the indicating arrow of the turn wheel points to the diameter of the positioned hole on the scale.
